(19) United States
(12) Patent Application Publication
(10) Pub. No.: US 2025/0158769 A1
(43) Pub. Date: May 15, 2025

(54) METHOD FOR REDUCING SOUNDING OVERHEAD BY SHORTENING TRIGGER-BASED PHYSICAL LAYER PROTOCOL DATA UNIT DURATION FOR TRIGGER-BASED IMPLICIT FEEDBACK, AND ASSOCIATED APPARATUS

(71) Applicant: MEDIATEK INC., Hsinchu City (TW)

(72) Inventors: Ming-Hsiang Tseng, Hsinchu City (TW); Cheng-En Hsieh, Hsinchu City (TW); Hao-Chih Yu, Hsinchu City (TW); Tzu-Hao Yu, Hsinchu City (TW)

(73) Assignee: MEDIATEK INC., Hsinchu City (TW)

(21) Appl. No.: 18/939,453

(22) Filed: Nov. 6, 2024

Related U.S. Application Data
(60) Provisional application No. 63/598,166, filed on Nov. 13, 2023.

(51) Int. Cl. H04L 5/00; H04B 7/06

(52) U.S. Cl. CPC H04L 5/005; H04B 7/0639

(57) ABSTRACT

A method for reducing sounding overhead by shortening TB-PPDU duration for trigger-based implicit feedback and associated apparatus are provided, where a non-AP STA device is wirelessly linking to an AP device, and a number of sounding dimension of the non-AP STA device is less than a maximum number of spatial streams of the AP device. The method may include: transmitting a first frame regarding TB-sounding as well as a trigger frame, with at least one field of at least one frame among the first frame and the trigger frame being set to shorten the TB-PPDU duration; and receiving a sounding feedback having the TB-PPDU duration to be the trigger-based implicit feedback, for use of generating a beamforming steering matrix for transmission beamforming, wherein the at least one field is set to shorten a time for receiving a useless part within the sounding feedback, for reducing the sounding overhead.

### CROSS REFERENCE TO RELATED APPLICATIONS

This application claims the benefit of U.S. Provisional Application No. 63/598,166, filed on Nov. 13, 2023. The content of the application is incorporated herein by reference.

### BACKGROUND

The present invention is related to communication control, and more particularly, to a method for reducing sounding overhead by shortening trigger-based (TB) physical layer (PHY) protocol data unit (PPDU) duration (TB-PPDU duration) for trigger-based implicit feedback, and associated apparatus such as a wireless transceiver device (e.g., an access point (AP) device) in a wireless communication system.

According to the related art, an AP device and a non-AP station (STA) device may be arranged to act as a beamformer and beamformee, respectively. For example, the AP device acting as the beamformer may transmit a PPDU using a beamforming steering matrix to the non-AP STA device acting as the beamformee, in order to enhance the overall performance. When the number of sounding dimension of the non-AP STA device is less than or equal to four and the maximum number of spatial streams (N_{SS}) of the AP device is greater than four, the beamforming capabilities of the AP device will not be fully utilized. Some suggestions may be proposed in the related art to try solving the problem, but some side effects may be introduced. Thus, a novel method and associated architecture are needed for solving the problems without introducing any side effect or in a way that is less likely to introduce a side effect.

### SUMMARY

It is an objective of the present invention to provide a method for reducing sounding overhead by shortening TB-PPDU duration for trigger-based implicit feedback, and associated apparatus such as a wireless transceiver device (e.g., an AP device) in a wireless communication system, in order to solve the above-mentioned problems.

At least one embodiment of the present invention provides a method for reducing sounding overhead by shortening TB-PPDU duration for trigger-based implicit feedback, where a non-AP STA device is wirelessly linking to an AP device in a wireless communication system, and a number of sounding dimension of the non-AP STA device is less than a maximum number of spatial streams of the AP device. For example, the method may comprise: transmitting a first frame regarding TB-sounding as well as a trigger frame, with at least one field of at least one frame among the first frame and the trigger frame being set to shorten the TB-PPDU duration; and receiving a sounding feedback having the TB-PPDU duration to be the trigger-based implicit feedback, for use of generating a beamforming steering matrix for transmission beamforming, wherein the at least one field is set to shorten a time for receiving a useless part within the sounding feedback, for reducing the sounding overhead.

At least one embodiment of the present invention provides an AP device for reducing sounding overhead by shortening TB-PPDU duration for trigger-based implicit feedback, where the AP device is one of multiple devices within a wireless communication system such as that mentioned above. The AP device may comprise a processing circuit that is arranged to control operations of the AP device. The AP device may further comprise at least one communication control circuit that is coupled to the processing circuit and arranged to perform communication control, wherein the aforementioned at least one communication control circuit is arranged to perform wireless communication operations with at least one other device among the multiple devices for the AP device. In addition, a non-AP STA device is wirelessly linking to the AP device, and a number of sounding dimension of the non-AP STA device is less than a maximum number of spatial streams of the AP device. For example, the AP device is arranged to transmit a first frame regarding TB-sounding as well as a trigger frame, with at least one field of at least one frame among the first frame and the trigger frame being set to shorten the TB-PPDU duration; and the AP device is arranged to receive a sounding feedback having the TB-PPDU duration to be the trigger-based implicit feedback, for use of generating a beamforming steering matrix for transmission beamforming, wherein the at least one field is set to shorten a time for receiving a useless part within the sounding feedback, for reducing the sounding overhead.

It is an advantage of the present invention that, through proper design, the method of the present invention, as well as the associated apparatus such as the AP device, can fully utilize the beamforming capabilities of the AP device while minimizing the sounding overhead, and more particularly, shorten the time for receiving the useless part within the sounding feedback, and therefore shorten the TB-PPDU duration, to enhance the overall performance. In addition, the method of the present invention and the associated apparatus such as the AP device can solve the related art problem without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communication system according to an embodiment of the present invention.

FIG. 2 illustrates, in the lower half part thereof, an implicit beamforming control scheme of a method for reducing sounding overhead by shortening TB-PPDU duration for trigger-based implicit feedback according to an embodiment of the present invention, where an explicit beamforming control scheme may be illustrated in the upper half part of FIG. 2 for better comprehension.

FIG. 3 illustrates a useless-part minimization control scheme of the method according to an embodiment of the present invention.

FIG. 4 illustrates an extremely high throughput (EHT) TB-sounding control scheme of the method according to an embodiment of the present invention.

FIG. 5 illustrates some EHT TB-sounding reduction ratios of the EHT TB-sounding control scheme shown in FIG. 4 according to an embodiment of the present invention.

FIG. 6 illustrates a high efficiency (HE) TB-sounding control scheme of the method according to an embodiment of the present invention.

FIG. 7 illustrates some HE TB-sounding reduction ratios of the HE TB-sounding control scheme shown in FIG. 6 according to an embodiment of the present invention.

FIG. 8 illustrates a trigger frame field adjustment control scheme of the method according to an embodiment of the present invention.

FIG. 9 illustrates a working flow of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

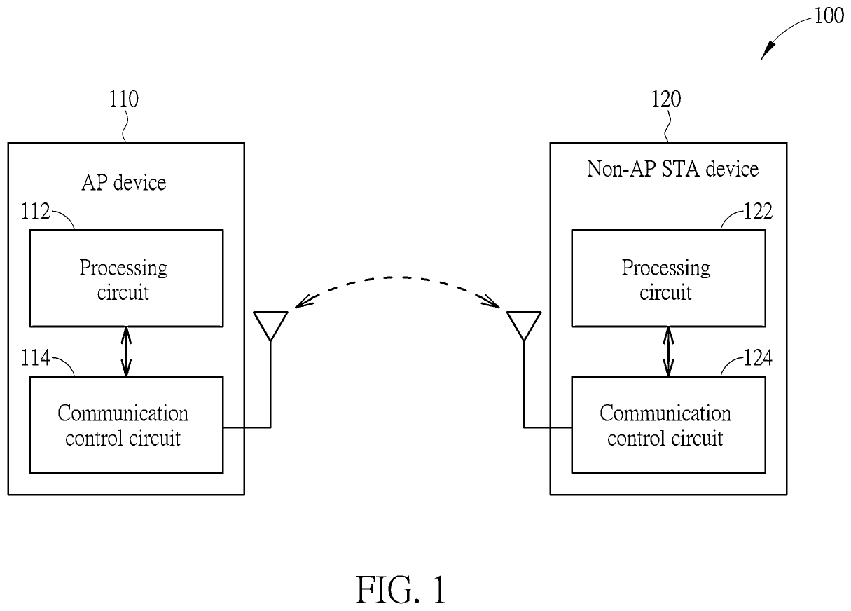

FIG. 1 is a diagram of a wireless communication system 100 according to an embodiment of the present invention. For better comprehension, the wireless communication system 100, as well as any wireless transceiver device #m among multiple wireless transceiver devices #1, . . . and #M therein, may be compatible or backward-compatible to one or more versions of the Institute of Electrical and Electronics Engineers (IEEE) 802.11 standards, but the present invention is not limited thereto. Among the multiple wireless transceiver devices #1, . . . and #M within the wireless communication system 100, a wireless transceiver device may be implemented as an AP device 110, and another wireless transceiver device may be implemented as a non-AP STA device 120, but the present invention is not limited thereto. For example, two or more wireless transceiver devices among the multiple wireless transceiver devices #1, . . . and #M may be implemented as multiple AP devices {110}. In another example, two or more wireless transceiver devices among the multiple wireless transceiver devices #1, . . . and #M may be implemented as multiple non-AP STA devices {120}. In some examples, two or more wireless transceiver devices among the multiple wireless transceiver devices #1, . . . and #M may be implemented as multiple AP devices {110}, and two or more other wireless transceiver devices among the multiple wireless transceiver devices #1, . . . and #M may be implemented as multiple non-AP STA devices {120}.

As shown in FIG. 1, the AP device 110 may comprise a processing circuit 112, at least one communication control circuit (e.g., one or more communication control circuits), which may be collectively referred to as the communication control circuit 114, and at least one antenna (e.g., one or more antennas) of the communication control circuit 114, and the non-AP STA device 120 may comprise a processing circuit 122, at least one communication control circuit (e.g., one or more communication control circuits), which may be collectively referred to as the communication control circuit 124, and at least one antenna (e.g., one or more antennas) of the communication control circuit 124. In the architecture shown in FIG. 1, the processing circuit 112 can be arranged to control operations of the AP device 110, and the communication control circuit 114 can be arranged to perform communication control, and more particularly, perform wireless communication operations with the network (or at least one other device therein such as the non-AP STA device 120) for the AP device 110. In addition, the processing circuit 122 can be arranged to control operations of the non-AP STA device 120, and the communication control circuit 124 can be arranged to perform communication control, and more particularly, perform wireless communication operations with the network (or at least one other device therein such as the AP device 110) for the non-AP STA device 120.

According to some embodiments, the processing circuit 112 can be implemented by way of at least one processor/microprocessor, at least one random access memory (RAM), at least one bus, etc., and the communication control circuit 114 can be implemented by way of at least one wireless network control circuit and at least one wired network control circuit, but the present invention is not limited thereto. Examples of the AP device 110 may include, but are not limited to: a Wi-Fi router. In addition, the processing circuit 122 can be implemented by way of at least one processor/microprocessor, at least one RAM, at least one bus, etc., and the communication control circuit 124 can be implemented by way of at least one wireless network control circuit, but the present invention is not limited thereto. Examples of the non-AP STA device 120 may include, but are not limited to: a multifunctional mobile phone, a laptop computer, an all-in-one computer and a wearable device.

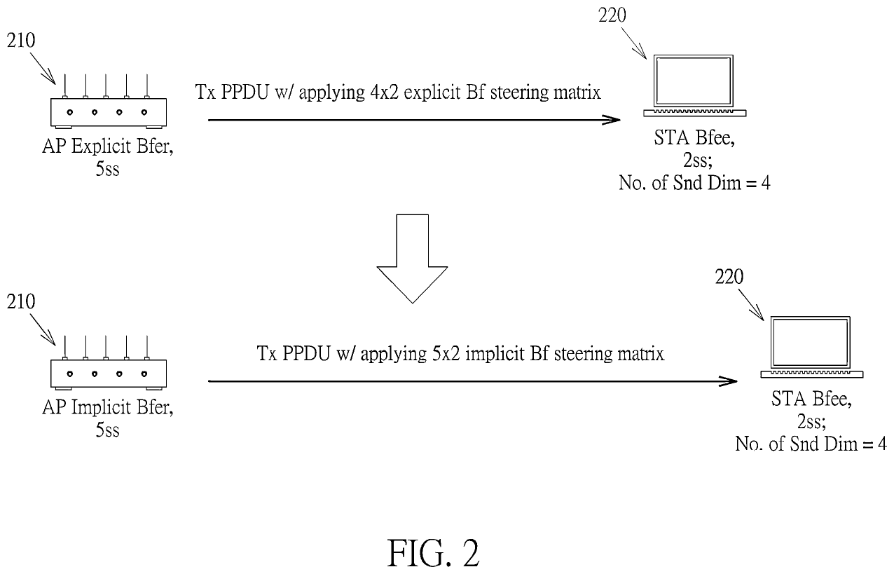

FIG. 2 illustrates, in the lower half part thereof, an implicit beamforming control scheme of a method for reducing sounding overhead by shortening TB-PPDU duration for trigger-based implicit feedback according to an embodiment of the present invention, where an explicit beamforming control scheme may be illustrated in the upper half part of FIG. 2 for better comprehension. For example, the AP device 110 and the non-AP STA device 120 may be arranged to act as a beamformer (or “Bfer”) 210 and a beamformee (of “Bfee”) 220, respectively, and may support the maximum number of spatial streams N_{SS}=5 (or “5ss”) and the maximum number of spatial streams N_{SS}=2 (or “2ss”) for transmission/reception, respectively. Assume that one or more functions of the wireless communication system 100 may be temporarily disabled to allow the AP device 110 acting as the beamformer 210 and supporting the maximum number of spatial streams N_{SS}=5 and the non-AP STA device 120 acting as the beamformee 220 and supporting the maximum number of spatial streams N_{SS}=2 to operate according to the explicit beamforming control scheme shown in the upper half part of FIG. 2, respectively (labeled “AP Explicit Bfer, 5ss” and “STA Bfee, 2ss” for brevity), but the present invention is not limited thereto. Based on the explicit beamforming control scheme, when the maximum number of spatial streams N_{SS} (or “Max NSS”) of the AP device 110 such as the beamformer 210 is greater than four and the number of sounding dimension (or “No. of Snd Dim”) of the non-AP STA device 120 such as the beamformee 220 is less than or equal to four, the beamformee 220 may estimate the channel quality to return a corresponding feedback report (e.g., a 4×2 feedback report or a 4×3 feedback report) to the beamformer 210, to allow the beamformer 210 to transmit a PPDU using a beamforming steering matrix to the beamformee 220, with the beamformer 210 applying this beamforming steering matrix such as a 4×2 explicit beamforming steering matrix corresponding to the explicit beamforming control scheme (labeled “Tx PPDU w/applying 4×2 explicit Bf steering matrix” for brevity). As a result, the beamforming capabilities of the AP device 110 (or the beamformer 210) will not be fully utilized.

As shown in the lower half part of FIG. 2, the AP device 110 (or the communications control circuit 114 therein) may operate according to the implicit beamforming control scheme to achieve a better overall performance. When the maximum number of spatial streams N_{SS} (or “Max NSS”) of the AP device 110 such as the beamformer 210 is greater than four and the number of sounding dimension (or “No. of Snd Dim”) of the non-AP STA device 120 such as the beamformee 220 is less than or equal to four, the beamformer 210 may estimate the channel quality, the channel quality at the beamformee 220, according to PHY header contents (e.g., certain contents of the PHY header) in a sounding feedback returned from the beamformee 220, and more particularly, generate another beamforming steering matrix such as a 5×2 beamforming steering matrix according to this channel quality estimation (or the channel quality estimation results thereof), and transmit a PPDU using this beamforming steering matrix to the beamformee 220, with the beamformer 210 applying the beamforming steering matrix such as the 5×2 implicit beamforming steering matrix corresponding to the implicit beamforming control scheme (labeled “Tx PPDU w/applying 5×2 implicit Bf steering matrix” for brevity), allowing the PPDU to be successfully received by the beamformee 220 at a longer distance as shown in FIG. 2. As a result, the throughput gain of the implicit beamforming control scheme is larger than that of the explicit beamforming control scheme when the AP's Max NSS>4 and the STA's No. of Snd Dim≤4, and therefore the overall performance of the wireless communication system 100 can be enhanced.

Based on the implicit beamforming control scheme, the AP device 110 such as the beamformer 210 can get the maximum beamforming gain by applying the maximum number of sounding dimension in the downlink data for its transmitting target device(s) such as STA(s). More particularly, the wireless communication system 100 (or the AP device 110 acting as the beamformer 210 and the non-AP STA device 120 acting as the beamformee 220) may operate according to one or more control schemes of the method in an efficient manner. For example, the one or more control schemes may comprise the implicit beamforming control scheme, as well as any control scheme among multiple other control schemes shown in some subsequent embodiments.

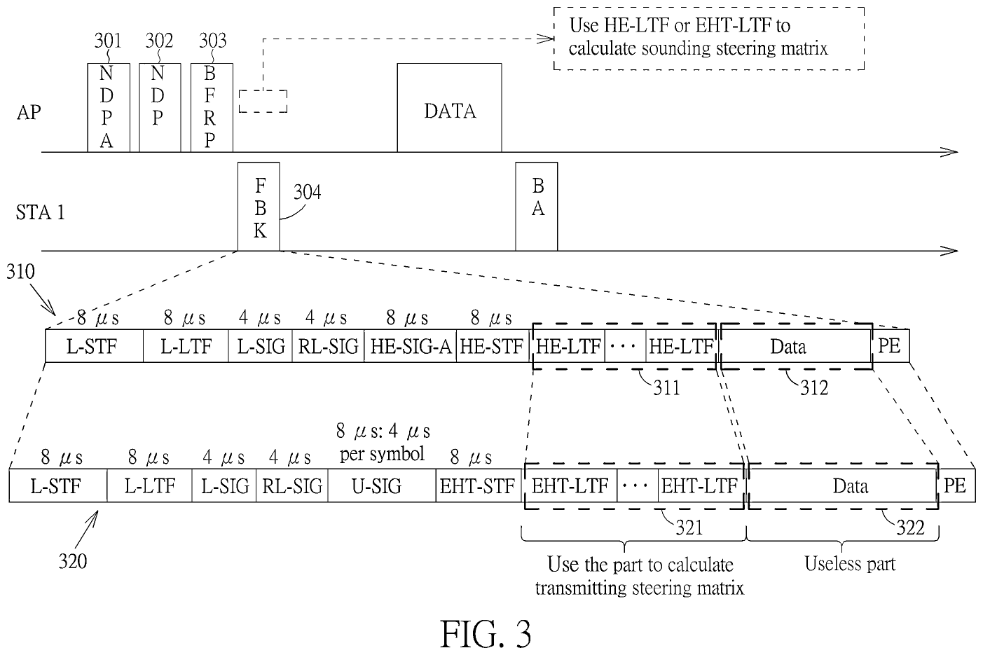

FIG. 3 illustrates a useless-part minimization control scheme of the method according to an embodiment of the present invention. The AP device 110 acting as the beamformer 210 (labeled “AP” for brevity) can use a useful part of the sounding feedback, such as the HE-Long Training field (LTF) or EHT-LTF in the PHY header of the sounding feedback, to calculate the beamforming steering matrix (which may also be referred to as the sounding steering matrix or the transmitting steering matrix), and control the non-AP STA device 120 acting as the beamformee 220 (labeled “STA 1” for brevity) to minimize a useless part of the sounding feedback, such as the data coming after the PHY header of the sounding feedback, in order to reduce the sounding overhead by shortening the TB-PPDU duration. For example, the non-AP STA device 120 may be wirelessly linking to the AP device 110 in the wireless communication system 100, and more particularly, the number of sounding dimension of the non-AP STA device 120 is less than the maximum number of spatial streams N_{SS} of the AP device 110, and the associated operations may comprise:
(1) the AP device 110 may transmit a first frame 301 regarding TB-sounding, and a second frame 302, as well as a trigger frame 303, with at least one field (e.g., one or more fields) of at least one frame (e.g., one or more frames) among the first frame 301 and the trigger frame 303 being set to shorten the TB-PPDU duration;
(2) the non-AP STA device 120 may transmit (or return) the aforementioned sounding feedback such as the sounding feedback 304 (labeled “FBK” for brevity) to the AP device 110, allowing the AP device 110 to calculate the beamforming steering matrix such as the sounding steering matrix according to the useful part of the sounding feedback 304 at the same time (or almost the same time);
(3) the AP device 110 may receive the sounding feedback 304 having the TB-PPDU duration to be the trigger-based implicit feedback (e.g., the sounding feedback trigged by the trigger frame 303 regarding the implicit beamforming control scheme), for use of generating the beamforming steering matrix such as the sounding steering matrix for transmission beamforming, where the aforementioned at least one field may be set (or adjusted) to shorten the time for receiving the useless part within the sounding feedback 304, for reducing the sounding overhead;
(4) the AP device 110 may transmit the PPDU carrying data such as user data, while using this beamforming steering matrix, to the non-AP STA device 120; and
(5) the non-AP STA device 120 may transmit (or return) a block acknowledgment (BA) to the AP device 110;
where the number of sounding dimension of the non-AP STA device 120 may be less than or equal to four, and the maximum number of spatial streams N_{SS} of the AP device 110 may be greater than four, but the present invention is not limited thereto. For example, the number of sounding dimension of the non-AP STA device 120 may be less than or equal to a first predetermined value, and the maximum number of spatial streams N_{SS} of the AP device 110 may be greater than the first predetermined value, where the first predetermined value may be greater than or equal to four.

As shown in FIG. 3, in the TB sounding sequence initiated by AP device 110 acting as the beamformer 210, the first frame 301 may be implemented as a null data PPDU (NDP) announcement (NDPA), the second frame 302 may be implemented as an NDP such as a sounding NDP, and the trigger frame 303 may be implemented as a beamforming report poll (BFRP) such as a BFRP Trigger, and therefore the first frame 301, the second frame 302 and the trigger frame 303 in the TB sounding sequence may also be referred to as the NDPA frame 301, the sounding NDP frame 302 and the BFRP Trigger frame 303, respectively. For example, the aforementioned at least one field may comprise at least one subfield of at least one STA information (STA Info) field within the NDPA, but the present invention is not limited thereto. In another example, the aforementioned at least one field may comprise at least one subfield of at least one information (Info) field within the BFRP. In some examples, the aforementioned at least one field may comprise the aforementioned at least one subfield of the aforementioned at least one STA Info field within the NDPA, and/or the aforementioned at least one subfield of the aforementioned at least one Info field within the BFRP.

For example, the sounding feedback 304 may be implemented according to the HE TB PPDU format 310. In this situation, the PHY header of the sounding feedback 304 may comprise multiple fields such as the Non-HT Short Training field (L-STF), the Non-HT-LTF (L-LTF), the Non-HT SIGNAL (L-SIG) field, the Repeated Non-HT SIGNAL (RL-SIG) field, the HE SIGNAL A (HE-SIG-A) field, the HE Short Training field (HE-STF) and the HE-LTFs 311, and the AP device 110 may use the useful part such as the HE-LTFs 311 to calculate the beamforming steering matrix such as the transmitting steering matrix. The AP device 110 may receive the whole of the sounding feedback 304 conforming to the HE TB PPDU format 310, including the PHY header thereof, starting from the L-STF and ending with the HE-LTFs 311, as well as the Data field 312 and the Packet Extension (PE) field, to complete the reception of the sounding feedback 304. When calculating the beamforming steering matrix, the AP device 110 may refer to the useful part such as the HE-LTFs 311, having no need to refer to the useless part such as the Data field 312. In addition, the AP device 110 may control the non-AP STA device 120 with the aforementioned at least one field to decrease and/or minimize the length of the useless part (e.g., the Data field 312), and more particularly, set or adjust the aforementioned at least one field to make at least one communication behavior indicated by the aforementioned at least one field regarding the sounding feedback 304 be minimized, in order to shorten the time for receiving the useless part (e.g., the Data field 312) within the sounding feedback 304, for reducing the sounding overhead.

In another example, the sounding feedback 304 may be implemented according to the EHT TB PPDU format 320. In this situation, the PHY header of the sounding feedback 304 may comprise multiple fields such as the L-STF, the L-LTF, the L-SIG field, the RL-SIG field, the U-SIG field, the EHT-STF and the EHT-LTFs 321, and the AP device 110 may use the useful part such as the EHT-LTFs 321 to calculate the beamforming steering matrix such as the transmitting steering matrix. The AP device 110 may receive the whole of the sounding feedback 304 conforming to the EHT TB PPDU format 320, including the PHY header thereof, starting from the L-STF and ending with the EHT-LTFs 321, as well as the Data field 322 and the PE field, to complete the reception of the sounding feedback 304. When calculating the beamforming steering matrix, the AP device 110 may refer to the useful part such as the EHT-LTFs 321, having no need to refer to the useless part such as the Data field 322. In addition, the AP device 110 may control the non-AP STA device 120 with the aforementioned at least one field to decrease and/or minimize the length of the useless part (e.g., the Data field 322), and more particularly, set or adjust the aforementioned at least one field to make the aforementioned at least one communication behavior indicated by the aforementioned at least one field regarding the sounding feedback 304 be minimized, in order to shorten the time for receiving the useless part (e.g., the Data field 322) within the sounding feedback 304, for reducing the sounding overhead.

No matter whether the sounding feedback 304 is implemented according to any format among various formats such as the HE TB PPDU format 310, the EHT TB PPDU format 320, etc., the aforementioned at least one field may comprise a first field, and the aforementioned at least one communication behavior may comprise a first communication behavior indicated by the first field. If the first communication behavior has a positive correlation with the first field, the AP device 110 may minimize and set a first field value of the first field, in order to shorten the time for receiving the useless part within the sounding feedback 304. If the first communication behavior has a negative correlation with the first field, the AP device 110 may maximize and set the first field value of the first field, in order to shorten the time for receiving the useless part within the sounding feedback 304. In addition, the AP device 110 may set a field value of any field among the aforementioned at least one field to make a communication behavior indicated by this field (i.e., the aforementioned any field) correspond to a minimized value, in order to shorten the time for receiving the useless part within the sounding feedback 304.

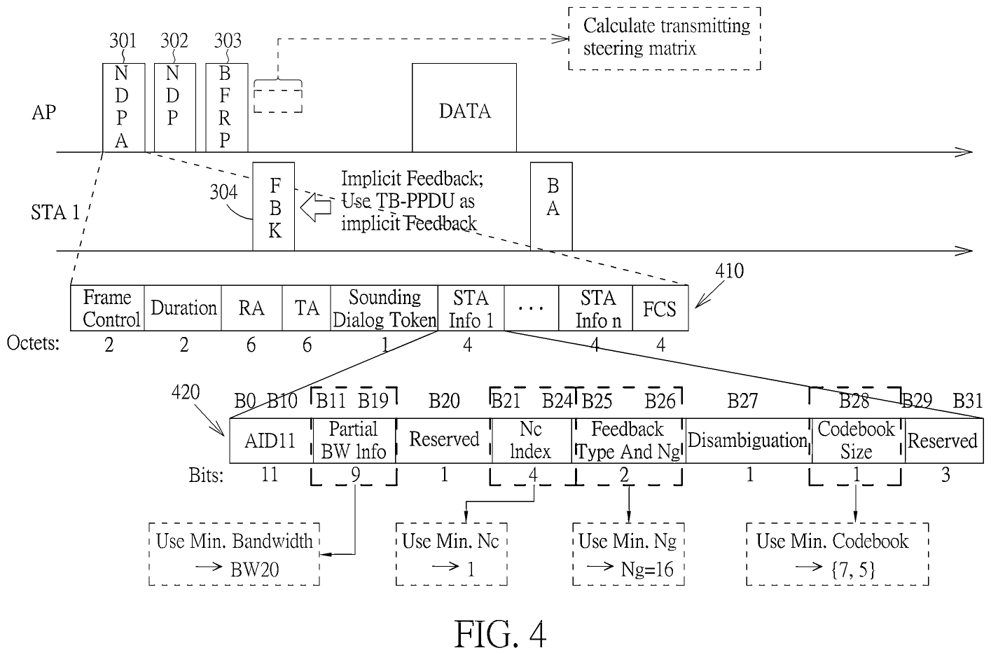

FIG. 4 illustrates an EHT TB-sounding control scheme of the method according to an embodiment of the present invention. For example, the aforementioned at least one subfield of the aforementioned at least one STA Info field within the NDPA may comprise one or a combination of a Partial Bandwidth Information (BW Info) subfield, a Feedback Type and Number of Subcarrier Grouping (Ng) subfield (which may be referred to as the Feedback Type And Ng subfield for brevity), a Codebook Size Subfield and a Number of Columns (Nc) subfield. As shown in FIG. 4, the first frame 301 which is implemented as the NDPA may conform to the NDPA frame format 410, which may comprise the Frame Control field, the Duration field, the Receiver Address (RA) field, the Transmitter Address (TA) field, the Sounding Dialog Token field, the aforementioned at least one STA Info field such as the STA Info fields 1 to n (e.g., “n” may be a positive integer) and the frame check sequence (FCS) field, and any STA Info field among the aforementioned at least one STA Info field, such as the STA Info field 1, may conform to the STA Info field format 420 in an EHT NDPA frame, but the present invention is not limited thereto. In addition, the STA Info field format 420 may comprise the AID11 subfield at the bits B0 to B10, the Partial BW Info subfield at the bits B11 to B19, the Reserved subfield at the bit B20, the Nc subfield such as the Nc Index subfield at the bits B21 to B24, the Feedback Type And Ng subfield at the bits B25 to B26, the Disambiguation subfield at the bit B27, the Codebook Size subfield at the bit B28 and the Reserved subfield at the bits B29 to B31.

For example, the AP device 110 may operate in at least one case among Cases A1, B1, C1 and D1, and the associated operations may comprise:
(A1) if the aforementioned at least one field comprises the Partial BW Info subfield at the bits B11 to B19, and the aforementioned at least one communication behavior comprises the partial bandwidth indicated by the Partial BW Info subfield, the AP device 110 may set the field value of this field to make the partial bandwidth be minimized and/or be a minimum/minimized bandwidth (labeled “Min. Bandwidth” for brevity), in order to shorten the time for receiving the useless part within the sounding feedback 304, for example, the partial bandwidth may be equal to the 20 MHz bandwidth (BW20);
(B1) if the aforementioned at least one field comprises the Feedback Type And Ng subfield at the bits B25 to B26, and the aforementioned at least one communication behavior comprises the subcarrier grouping result corresponding to the Ng indicated by the bit B26 in the Feedback Type And Ng subfield, the AP device 110 may set the field value of this field to make the Ng indicated by the bit B26 be maximized and/or be a maximum/maximized value for minimizing the subcarrier grouping result having a negative correlation with the Ng (labeled “Min. Ng” for brevity), in order to shorten the time for receiving the useless part within the sounding feedback 304, for example, Ng=16;
(C1) if the aforementioned at least one field comprises the Codebook Size subfield at the bit B28, and the aforementioned at least one communication behavior comprises the codebook size indicated by the bit B28 in the Codebook Size subfield, the AP device 110 may set the field value of this field to make the codebook size be minimized (labeled “Min. Codebook” for brevity), in order to shorten the time for receiving the useless part within the sounding feedback 304, for example, the codebook size expressed with quantization resolution (ϕ, ψ)={7, 5}; and
(D1) if the aforementioned at least one field comprises the Nc subfield such as the Nc Index subfield at the bits B21 to B24, and the aforementioned at least one communication behavior comprises the Nc indicated by the Nc subfield such as the Nc Index subfield, the AP device 110 may set the field value of this field to make the Nc be minimized and/or be a minimum/minimized value (labeled “Min. Nc” for brevity), in order to shorten the time for receiving the useless part within the sounding feedback 304, for example, Nc=1.

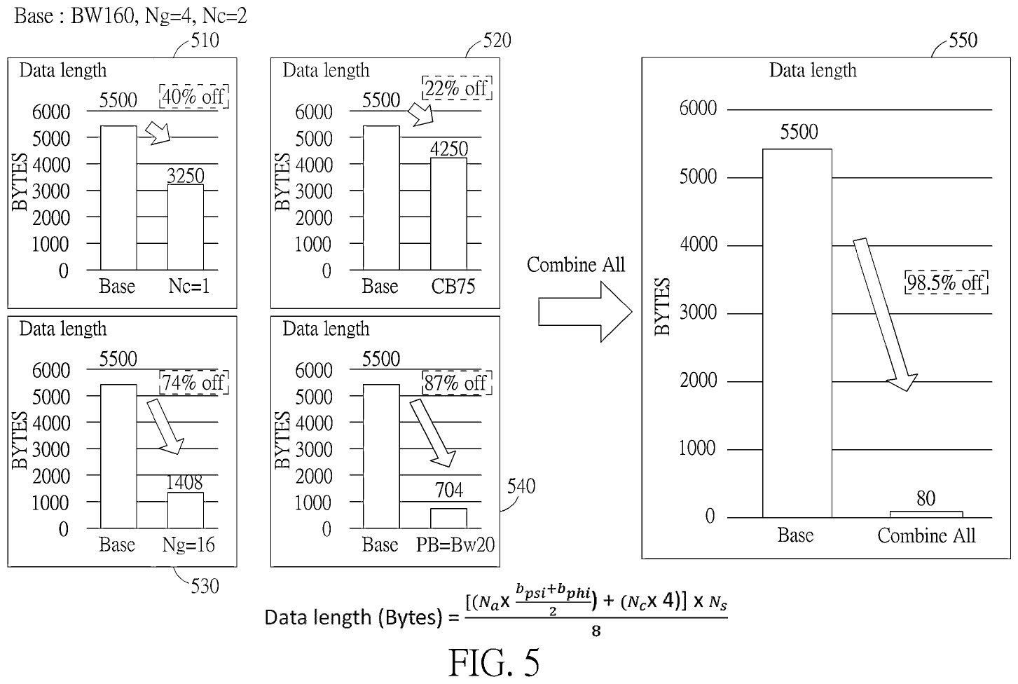

FIG. 5 illustrates some EHT TB-sounding reduction ratios of the EHT TB-sounding control scheme shown in FIG. 4 according to an embodiment of the present invention. The base for comparison may comprise the partial bandwidth indicated by the Partial BW Info subfield being equal to the 160 MHz bandwidth (BW160), the Ng indicated by the bit B26 in the Feedback Type And Ng subfield being equal to four, the codebook size indicated by the bit B28 in the Codebook Size subfield being equal to the codebook size (ϕ, ψ)={9, 7}, and the Nc indicated by the Nc subfield such as the Nc Index subfield being equal to two (labeled “Base: BW160, Ng=4, Nc=2” for brevity). For example, the data length of the sounding feedback 304 in Cases D1, C1, B1 and A1 for Nc=1, the codebook (CB) size (ϕ, ψ)={7, 5} (labeled “CB75” for brevity), Ng=16 and the partial bandwidth (PB) being equal to the BW20 (labeled “PB=Bw20” for brevity) may be illustrated as shown in the comparison results 510, 520, 530 and 540 measured in units of bytes, respectively, and the data length of the sounding feedback 304 in the combined case {A1, B1, C1, D1} of combining all cases among Cases A1, B1, C1 and D1 may be illustrated as shown in the comparison result 550 measured in units of bytes, where the respective EHT TB-sounding reduction ratios of Cases D1, C1, B1 and A1 may be approximately equal to 40%, 22%, 74% and 87%, respectively, and the EHT TB-sounding reduction ratio of the combined case {A1, B1, C1, D1} may be approximately equal to 98.5%, but the present invention is not limited thereto. For better comprehension, the data length of the sounding feedback 304 may be expressed as follows:

$$Data Length ( Bytes ) = [ ( N a \times ( ( {b}_{p s i} + {b}_{p h i} ) / 2 ) ) + ( N c \times 4 ) ] \times Ns / 8 ;$$

where “Nc” may represent the number of columns in a compressed beamforming feedback matrix, “Na” may represent the number of angles used for the compressed beamforming feedback matrix, “Ns” may represent the number of subcarriers for which the compressed beamforming feedback matrix is sent back from the beamformee 220 to the beamformer 210, and “bₚₛᵢ” and “bₚₕᵢ” may represent the associated parameters b_{ψ} and b_{ϕ} regarding beamforming, respectively. For brevity, similar descriptions for this embodiment are not repeated in detail here.

TABLE 1

| | |
|---|---|
| B0 | B1 to B8 |
| Resolution | Feedback Bitmap |
| 1 bit | 8 bits |

Table 1 illustrates an example of the Partial BW Info subfield format, where the Partial BW Info subfield format shown in Table 1 may comprise the Resolution subfield at the bit B0 and the Feedback Bitmap subfield at the bits B1 to B8. The Resolution subfield may indicate the resolution bandwidth for each bit in the Feedback Bitmap subfield. In addition, the Feedback Bitmap subfield may indicate the request of each resolution bandwidth from the lowest frequency to the highest frequency with B1 indicating the lowest resolution bandwidth. Each bit in the Feedback Bitmap subfield may be set to 1 if the feedback is requested on the corresponding resolution bandwidth. According to some embodiments, the Partial BW Info subfield among the subfields of the aforementioned any STA Info field among the aforementioned at least one STA Info field may conform to the Partial BW Info subfield format shown in Table 1, but the present invention is not limited thereto.

TABLE 2

| | |
|---|---|
| B0 to B6 | B7 to B13 |
| RU Start Index | RU End Index |
| 7 bits | 7 bits |

Table 2 illustrates another example of the Partial BW Info subfield format, where the Partial BW Info subfield format shown in Table 2 may comprise the RU Start Index subfield at the bits B0 to B6 and the RU End Index subfield at the bits B7 to B13. The RU Start Index subfield may indicate the first 26-tone RU for which the AP device 110 acting as the beamformer 210 (e.g., the HE beamformer) is requesting feedback. In addition, the RU End Index subfield may indicate the last 26-tone RU for which the AP device 110 acting as the beamformer 210 (e.g., the HE beamformer) is requesting feedback. The value of the RU Start Index subfield may be less than or equal to the value of the RU End Index subfield. Additionally, the RU Start Index subfield and RU End Index subfield may depend on the bandwidth of the NDPA frame 301. For example, when NDPA frame 301 represents the HE NDPA frame, the bandwidth thereof may be indicated by the TXVECTOR parameter CH_BANDWIDTH if this frame is carried in an HE, very high throughput (VHT) or high throughput (HT) PPDU, and may be indicated by the TXVECTOR parameter CH_BANDWIDTH_IN_NON_HT if this frame is carried in a non-HT duplicate PPDU, and may be 20 MHz if the frame is carried in non-HT PPDU. According to some embodiments, the Partial BW Info subfield among the subfields of the aforementioned any STA Info field among the aforementioned at least one STA Info field may conform to the Partial BW Info subfield format shown in Table 2, but the present invention is not limited thereto.

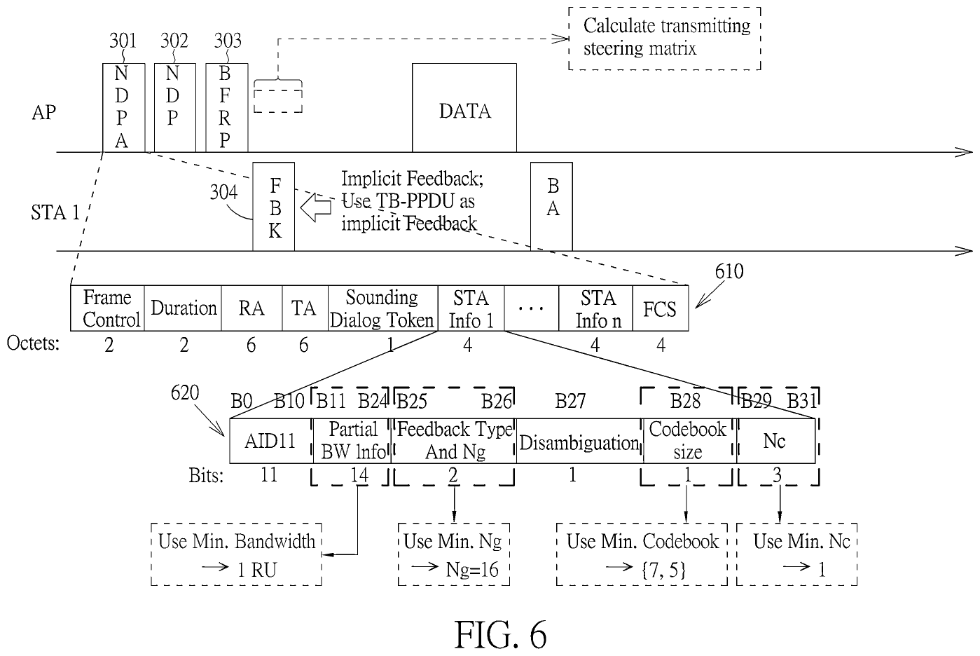

FIG. 6 illustrates an HE TB-sounding control scheme of the method according to an embodiment of the present invention. For example, the aforementioned at least one subfield of the aforementioned at least one STA Info field within the NDPA may comprise one or a combination of the Partial BW Info subfield, the Feedback Type And Ng subfield, the Codebook Size subfield and the Nc subfield. As shown in FIG. 6, the first frame 301 which is implemented as the NDPA may conform to the NDPA frame format 610, which may comprise the Frame Control field, the Duration field, the RA field, the TA field, the Sounding Dialog Token field, the aforementioned at least one STA Info field such as the STA Info fields 1 to n (e.g., “n” may be a positive integer) and the FCS field, and any STA Info field among the aforementioned at least one STA Info field, such as the STA Info field 1, may conform to the STA Info field format 620 in an HE NDPA frame if the AID11 subfield is not 2047, but the present invention is not limited thereto. In addition, the STA Info field format 620 may comprise the AID11 subfield at the bits B0 to B10, the Partial BW Info subfield at the bits B11 to B24, the Feedback Type And Ng subfield at the bits B25 to B26, the Disambiguation subfield at the bit B27, the Codebook Size subfield at the bit B28 and the Nc subfield at the bits B29 to B31.

For example, the AP device 110 may operate in at least one case among Cases A2, B2, C2 and D2, and the associated operations may comprise:
(A2) if the aforementioned at least one field comprises the Partial BW Info subfield at the bits B11 to B24, and the aforementioned at least one communication behavior comprises the partial bandwidth indicated by the Partial BW Info subfield, the AP device 110 may set the field value of this field to make the partial bandwidth be minimized and/or be the minimum/minimized bandwidth (labeled “Min. Bandwidth” for brevity), in order to shorten the time for receiving the useless part within the sounding feedback 304, for example, the partial bandwidth may be equal to the bandwidth of one resource unit (RU);
(B2) if the aforementioned at least one field comprises the Feedback Type And Ng subfield at the bits B25 to B26, and the aforementioned at least one communication behavior comprises the subcarrier grouping result corresponding to the Ng indicated by the bit B26 in the Feedback Type And Ng subfield, the AP device 110 may set the field value of this field to make the Ng indicated by the bit B26 be maximized and/or be a maximum/maximized value for minimizing the subcarrier grouping result having a negative correlation with the Ng (labeled “Min. Ng” for brevity), in order to shorten the time for receiving the useless part within the sounding feedback 304, for example, Ng=16;
(C2) if the aforementioned at least one field comprises the Codebook Size subfield at the bit B28, and the aforementioned at least one communication behavior comprises the codebook size indicated by the bit B28 in the Codebook Size subfield, the AP device 110 may set the field value of this field to make the codebook size be minimized (labeled “Min. Codebook” for brevity), in order to shorten the time for receiving the useless part within the sounding feedback 304, for example, the codebook size expressed with quantization resolution (ϕ, ψ)={7, 5}; and
(D2) if the aforementioned at least one field comprises the Nc subfield at the bits B29 to B31, and the aforementioned at least one communication behavior comprises the Nc indicated by the Nc subfield, the AP device 110 may set the field value of this field to make the Nc be minimized and/or be a minimum/minimized value (labeled “Min. Nc” for brevity), in order to shorten the time for receiving the useless part within the sounding feedback 304, for example, Nc=1.

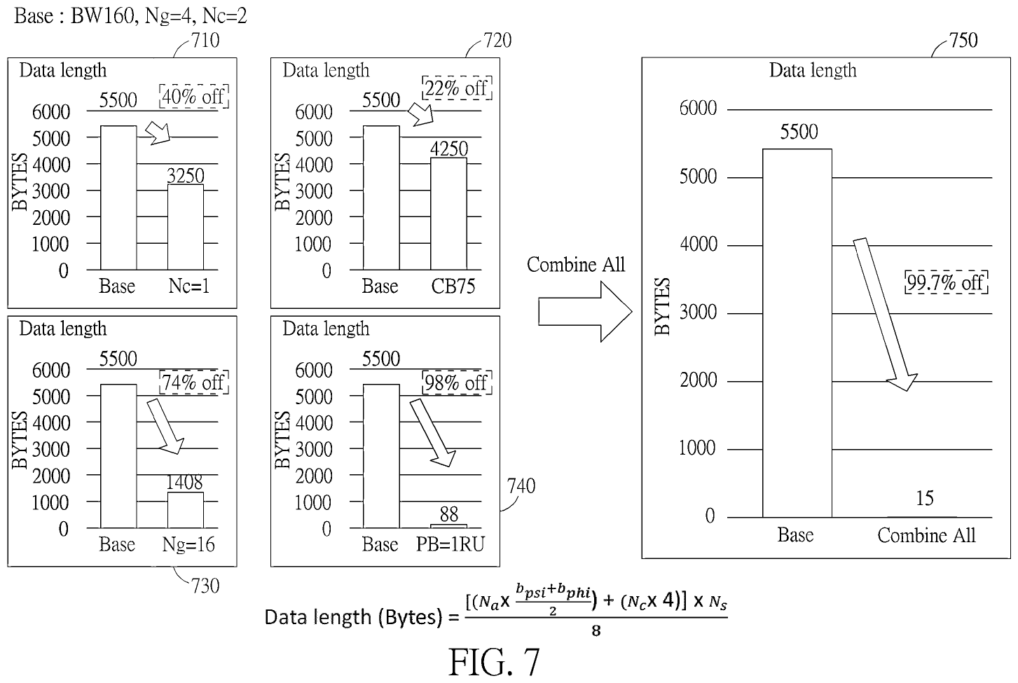

FIG. 7 illustrates some HE TB-sounding reduction ratios of the HE TB-sounding control scheme shown in FIG. 6 according to an embodiment of the present invention. The base for comparison may comprise the partial bandwidth indicated by the Partial BW Info subfield being equal to the BW160, the Ng indicated by the bit B26 in the Feedback Type And Ng subfield being equal to four, the codebook size indicated by the bit B28 in the Codebook Size subfield being equal to the codebook size (ϕ, ψ)={9, 7}, and the Nc indicated by the Nc subfield being equal to two (labeled “Base: BW160, Ng=4, Nc=2” for brevity). For example, the data length of the sounding feedback 304 in Cases D2, C2, B2 and A2 for Nc=1, the codebook (CB) size (ϕ, ψ)={7, 5} (labeled “CB75” for brevity), Ng=16 and the partial bandwidth (PB) being equal to one RU (labeled “PB=1 RU” for brevity) may be illustrated as shown in the comparison results 710, 720, 530 and 740 measured in units of bytes, respectively, and the data length of the sounding feedback 304 in the combined case {A2, B2, C2, D2} of combining all cases among Cases A2, B2, C2 and D2 may be illustrated as shown in the comparison result 750 measured in units of bytes, where the respective HE TB-sounding reduction ratios of Cases D2, C2, B2 and A2 may be approximately equal to 40%, 22%, 74% and 98%, respectively, and the HE TB-sounding reduction ratio of the combined case {A2, B2, C2, D2} may be approximately equal to 99.7%, but the present invention is not limited thereto. For brevity, similar descriptions for this embodiment are not repeated in detail here.

For better comprehension, some implementation details regarding the aforementioned any field (e.g., the first field) among the aforementioned at least one field may be further described with Cases A0, B0, C0 and D0 as follows:
(A0) if the aforementioned any field represents the Partial BW Info subfield (e.g., the Partial BW Info subfield at the bits B11 to B19 in the embodiment shown in FIG. 4, or the Partial BW Info subfield at the bits B11 to B24 in the embodiment shown in FIG. 6) of the aforementioned at least one STA Info field within the first frame 301 which is implemented as the NDPA, and the first communication behavior represents the partial bandwidth indicated by the Partial BW Info subfield, the AP device 110 may set the field value of this field to make the partial bandwidth be minimized, in order to shorten the time for receiving the useless part within the sounding feedback 304, for example, the partial bandwidth may be equal to any bandwidth among the BW20 and the bandwidth of one RU;
(B0) if the aforementioned any field represents the Feedback Type And Ng subfield (e.g., the Feedback Type And Ng subfield at the bits B25 to B26 in any of the embodiments respectively shown in FIG. 4 and FIG. 6) of the aforementioned at least one STA Info field within the first frame 301 which is implemented as the NDPA, and the first communication behavior represents the subcarrier grouping result corresponding to the Ng indicated by a first predetermined bit (e.g., the bit B26) in the Feedback Type And Ng subfield, the AP device 110 may set the field value of this field to make the Ng indicated by the first predetermined bit (e.g., the bit B26) be maximized, for minimizing the subcarrier grouping result having a negative correlation with the Ng, in order to shorten the time for receiving the useless part within the sounding feedback 304, for example, Ng=16;
(C0) if the aforementioned any field represents the Codebook Size subfield (e.g., the Codebook Size subfield at the bit B28 in any of the embodiments respectively shown in FIG. 4 and FIG. 6) of the aforementioned at least one STA Info field within the first frame 301 which is implemented as the NDPA, and the first communication behavior represents the codebook size indicated by a second predetermined bit (e.g., the bit B28) in the Codebook Size subfield, the AP device 110 may set the field value of this field to make the codebook size be minimized, in order to shorten the time for receiving the useless part within the sounding feedback 304, for example, the codebook size expressed with quantization resolution (ϕ, ψ)={7, 5}; and
(D0) if the aforementioned any field represents the Nc subfield (e.g., the Nc subfield such as the Nc index subfield at the bits B21 to B24 in the embodiment shown in FIG. 4, or the Nc subfield at the bits B29 to B31 in the embodiment shown in FIG. 6) of the aforementioned at least one STA Info field within the first frame 301 which is implemented as the NDPA, and the first communication behavior represents the Nc indicated by the Nc subfield, the AP device 110 may set the field value of this field to make the Nc be minimized, in order to shorten the time for receiving the useless part within the sounding feedback 304, for example, Nc=1.

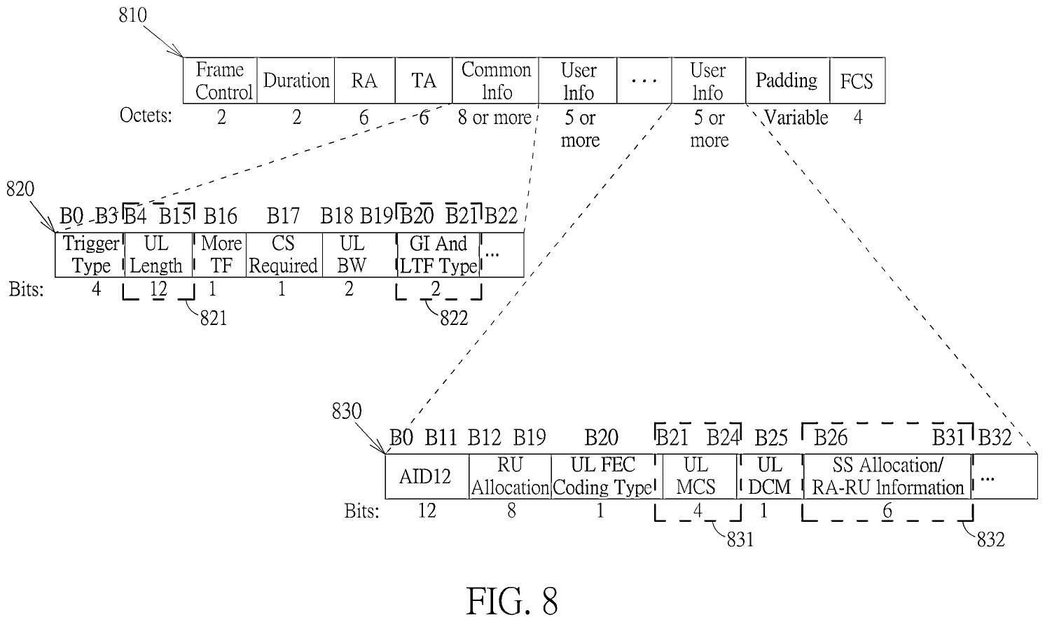

FIG. 8 illustrates a trigger frame field adjustment control scheme of the method according to an embodiment of the present invention. For example, the aforementioned at least one Info field may comprise a Common Info field and at least one User Info field, and more particularly, the aforementioned at least one subfield of the aforementioned at least one Info field within the BFRP may comprise one or a combination of an Uplink (UL) Length subfield of the Common Info field, a Guard Interval (GI) and Long Training Field (LTF) Type subfield (which may be referred to as the GI And LTF Type subfield for brevity) of the Common Info field, an UL Modulation and Coding Scheme (MCS) subfield of any User Info field among the aforementioned at least one User Info field and a Spatial Streams (SS) Allocation/Random Access Resource Unit (RA-RU) Information subfield (which may be referred to as the SS Allocation subfield for brevity) of the aforementioned any User Info field. As shown in FIG. 8, the trigger frame 303 which is implemented as the BFRP may conform to the BFRP Trigger frame format 810, which may comprise the Frame Control field, the Duration field, the RA field, the TA field, the Common Info field, at least one User Info field (e.g., one or more User Info field) such as the User Info field mentioned above, the Padding field and the FCS field, where the Common Info field may conform to the Common Info field format 820, and the aforementioned any User Info field among the aforementioned at least one User Info field may conform to the User Info field format 830, but the present invention is not limited thereto. In addition, the User Info field format 820 may comprise the Trigger Type subfield at the bits B0 to B3, the UL Length subfield at the bits B4 to B15, the More TF subfield at the bit B16, the CS Required subfield at the bit B17, the UL BW subfield at the bits B18 to B19, the GI And LTF Type subfield at the bits B20 to B21, and multiple subsequent subfields starting from bit B22, and the User Info field format 830 may comprise the AID12 subfield (e.g., the AID12 subfield having the subfield value that is equal to the 12 LSBs of the AID of the non-AP STA 120) at the bits B0 to B11, the RU Allocation subfield at the bits B12 to B19, the UL Forward Error Correction (FEC) Coding Type subfield at the bit B20, the UL MCS subfield at the bits B21 to B24, the UL DCM subfield at the bit B25, the SS Allocation/RA-RU Information subfield at the bits B26 to B31, and multiple subsequent subfields starting from bit B32.

For example, the AP device 110 may operate in at least one case among Cases A3, B3, C3 and D3, and the associated operations may comprise:
(A3) if the aforementioned at least one field comprises the UL Length subfield at the bits B4 to B15 within the Common Info field conforming to the Common Info field format 820, and the aforementioned at least one communication behavior comprises the UL length indicated by the UL Length subfield, the AP device 110 may set the field value of this field to make the UL length be minimized and/or be a minimum/minimized length, in order to shorten the time for receiving the useless part within the sounding feedback 304;
(B3) if the aforementioned at least one field comprises the GI And LTF Type subfield at the bits B20 to B21 within the Common Info field conforming to the Common Info field format 820, and the aforementioned at least one communication behavior comprises the GI and LTF length corresponding to the GI and LTF type indicated by the GI And LTF Type subfield, the AP device 110 may set the field value of this field to make the GI and LTF length (e.g., the total length of a combination of a GI and one or more LTFs) be minimized and/or be a minimum/minimized length, in order to shorten the time for receiving the useless part within the sounding feedback 304;
(C3) if the aforementioned at least one field comprises the UL MCS subfield at the bits B21 to B24 within the User Info field conforming to the User Info field format 830, and the aforementioned at least one communication behavior comprises the average coding size corresponding to the MCS indicated by the UL MCS subfield, the AP device 110 may set the field value of this field to make the average coding size (e.g., the average size of the encoding result of using the modulation order and the FEC coding rate in the MCS) be minimized and/or be a minimum/minimized size, in order to shorten the time for receiving the useless part within the sounding feedback 304; and
(D3) if the aforementioned at least one field comprises the SS Allocation subfield at the bits B26 to B31 within the User Info field conforming to the User Info field format 830, and the aforementioned at least one communication behavior comprises the average transmission time corresponding to the SS range indicated by the SS Allocation subfield, the AP device 110 may set the field value of this field to make the average transmission time (e.g., the average time required for transmitting with the spatial streams in the SS range) be minimized and/or be a minimum/minimized value, in order to shorten the time for receiving the useless part within the sounding feedback 304;
but the present invention is not limited thereto. For brevity, similar descriptions for this embodiment are not repeated in detail here.

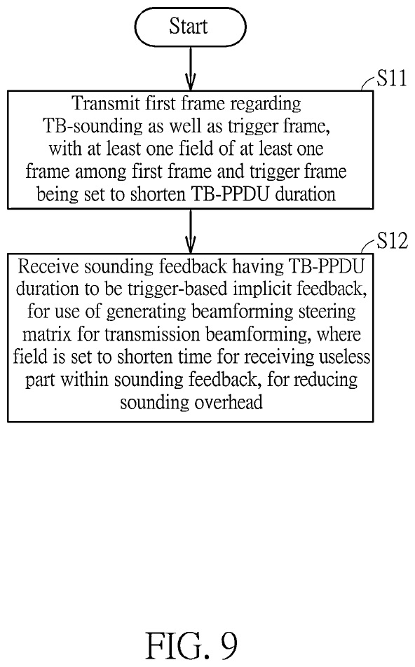

FIG. 9 illustrates a working flow of the method according to an embodiment of the present invention. The wireless transceiver device #m such as the AP device 110 may operate according to the working flow shown in FIG. 9, but the present invention is not limited thereto.

In Step S11, the AP device 110 may transmit the first frame 301 regarding the TB-sounding, and more particularly, further transmit the second frame 302 coming after the first frame 301, as well as the trigger frame 303, with the aforementioned at least one field of the aforementioned at least one frame among the first frame 301 and the trigger frame 303 being set to shorten the TB-PPDU duration. For example, the first frame 301, the second frame 302 and the trigger frame 303 may be implemented as the NDPA, the sounding NDP and the BFRP Trigger, respectively, and therefore may also be referred to as the NDPA frame 301, the sounding NDP frame 302 and the BFRP Trigger frame 303, respectively.

In Step S12, the AP device 110 may receive the sounding feedback 304 having the TB-PPDU duration to be the trigger-based implicit feedback, for use of generating the beamforming steering matrix for the transmission beamforming, where the aforementioned at least one field may be set (or adjusted) to shorten the time for receiving the useless part (e.g., the Data field 312 for the case that the sounding feedback 304 is implemented according to the HE TB PPDU format 310, or the Data field 322 for the case that the sounding feedback 304 is implemented according to the EHT TB PPDU format 320) within the sounding feedback 304, for reducing the sounding overhead. For brevity, similar descriptions for this embodiment are not repeated in detail here.

For better comprehension, the method may be illustrated with the working flow shown in FIG. 9, but the present invention is not limited thereto. According to some embodiments, one or more steps may be added, deleted, or changed in the working flow shown in FIG. 9.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for reducing sounding overhead by shortening trigger-based (TB) physical layer (PHY) protocol data unit (PPDU) duration (TB-PPDU duration) for trigger-based implicit feedback, wherein a non-access-point station (non-AP STA) device is wirelessly linking to an access point (AP) device, and a number of sounding dimension of the non-AP STA device is less than a maximum number of spatial streams of the AP device, the method comprising:
transmitting a first frame regarding TB-sounding as well as a trigger frame, with at least one field of at least one frame among the first frame and the trigger frame being set to shorten the TB-PPDU duration; and
receiving a sounding feedback having the TB-PPDU duration to be the trigger-based implicit feedback, for use of generating a beamforming steering matrix for transmission beamforming, wherein the at least one field is set to shorten a time for receiving a useless part within the sounding feedback, for reducing the sounding overhead.

2. The method of claim 1, wherein the number of sounding dimension of the non-AP STA device is less than or equal to a first predetermined value, and the maximum number of spatial streams of the AP device is greater than the first predetermined value, wherein the first predetermined value is greater than or equal to four.

3. The method of claim 1, wherein the first frame is implemented as a null data PPDU (NDP) announcement (NDPA), and the at least one field comprises at least one subfield of at least one station information (STA Info) field within the NDPA.

4. The method of claim 3, wherein the at least one subfield of the at least one STA Info field within the NDPA comprises one or a combination of a partial bandwidth information (BW Info) subfield, a feedback type and number of subcarrier grouping (Ng) subfield, a codebook size subfield and a number of columns (Nc) subfield.

5. The method of claim 1, wherein the trigger frame is implemented as a beamforming report poll (BFRP), and the at least one field comprises at least one subfield of at least one information (Info) field within the BFRP.

6. The method of claim 5, wherein the at least one Info field comprises a common Info field and at least one user Info field; and the at least one subfield of the at least one Info field within the BFRP comprises one or a combination of an uplink (UL) length subfield of the common Info field, a guard interval (GI) and long training field (LTF) type subfield of the common Info field, an UL modulation and coding scheme (MCS) subfield of any user Info field among the at least one user Info field and a spatial streams (SS) allocation subfield of the any user Info field.

7. The method of claim 1, wherein the at least one field is set to make at least one communication behavior indicated by the at least one field regarding the sounding feedback be minimized, in order to shorten the time for receiving the useless part within the sounding feedback.

8. The method of claim 7, wherein the at least one field comprises a first field, and the at least one communication behavior comprises a first communication behavior indicated by the first field, wherein:
if the first communication behavior has a positive correlation with the first field, a first field value of the first field is minimized, in order to shorten the time for receiving the useless part within the sounding feedback; and
if the first communication behavior has a negative correlation with the first field, the first field value of the first field is maximized, in order to shorten the time for receiving the useless part within the sounding feedback.

9. The method of claim 1, wherein a field value of any field among the at least one field is set to make a communication behavior indicated by the any field correspond to a minimized value, in order to shorten the time for receiving the useless part within the sounding feedback.

10. The method of claim 9, wherein:
if the any field represents a partial bandwidth information (BW Info) subfield of at least one STA information (STA Info) field within the first frame which is implemented as a null data PPDU (NDP) announcement (NDPA), and the first communication behavior represents a partial bandwidth indicated by the partial BW Info subfield, the field value of the any field is set to make the partial bandwidth be minimized, in order to shorten the time for receiving the useless part within the sounding feedback;
if the any field represents a feedback type and number of subcarrier grouping (Ng) subfield of the at least one STA Info field within the first frame which is implemented as the NDPA, and the first communication behavior represents a subcarrier grouping result corresponding to a Ng indicated by a first predetermined bit in the feedback type and Ng subfield, the field value of the any field is set to make the Ng indicated by the first predetermined bit be maximized, for minimizing the subcarrier grouping result having a negative correlation with the Ng, in order to shorten the time for receiving the useless part within the sounding feedback;
if the any field represents a codebook size subfield of the at least one STA Info field within the first frame which is implemented as the NDPA, and the first communication behavior represents a codebook size indicated by a second predetermined bit in the codebook size subfield, the field value of the any field is set to make the codebook size be minimized, in order to shorten the time for receiving the useless part within the sounding feedback; and
if the any field represents a number of columns (Nc) subfield of the at least one STA Info field within the first frame which is implemented as the NDPA, and the first communication behavior represents a Nc indicated by the Nc subfield, the field value of the any field is set to make the Nc be minimized, in order to shorten the time for receiving the useless part within the sounding feedback.

11. The method of claim 10, wherein:
if the any field represents the partial BW Info subfield, the partial bandwidth is equal to any bandwidth among a 20 MHz bandwidth (BW20) and a bandwidth of one resource unit (RU);
if the any field represents the feedback type and Ng subfield, Ng=16;
if the any field represents the codebook size subfield, the codebook size expressed with quantization resolution (ϕ, ψ)={7, 5}; and
if the any field represents the Nc subfield, Nc=1.

12. An access point (AP) device, for reducing sounding overhead by shortening trigger-based (TB) physical layer (PHY) protocol data unit (PPDU) duration (TB-PPDU duration) for trigger-based implicit feedback, the AP device comprising:
a processing circuit, arranged to control operations of the AP device; and
at least one communication control circuit, coupled to the processing circuit, arranged to perform communication control, wherein the at least one communication control circuit is arranged to perform wireless communication operations with at least one other device within a wireless communication system for the AP device, wherein a non-access-point station (non-AP STA) device is wirelessly linking to the AP device, and a number of sounding dimension of the non-AP STA device is less than a maximum number of spatial streams of the AP device;
wherein:
the AP device is arranged to transmit a first frame regarding TB-sounding as well as a trigger frame, with at least one field of at least one frame among the first frame and the trigger frame being set to shorten the TB-PPDU duration; and
the AP device is arranged to receive a sounding feedback having the TB-PPDU duration to be the trigger-based implicit feedback, for use of generating a beamforming steering matrix for transmission beamforming, wherein the at least one field is set to shorten a time for receiving a useless part within the sounding feedback, for reducing the sounding overhead.
